(19) United States
(12) Patent Application Publication
(10) Pub. No.: US 2013/0128603 A1
(43) Pub. Date: May 23, 2013

(54) VEHICLE HEADLAMP SYSTEM

(71) Applicant: PING-YU CHEN, Chu-Nan (TW)

(72) Inventor: PING-YU CHEN, Chu-Nan (TW)

(73) Assignee: FOXSEMICON INTEGRATED TECHNOLOGY, INC., Chu-Nan (TW)

(21) Appl. No.: 13/300,622

(22) Filed: Nov. 20, 2011

(51) Int. Cl. B60Q 1/04

(52) U.S. Cl. 362/545

(57) ABSTRACT

A vehicle headlamp system includes a lamp device and a control device to control the brightness thereof while in operation. The lamp device includes at least a first light emitting diode unit providing a first color temperature, and at least a second light emitting diode unit providing a second color temperature different from the first color temperature. The control device is coupled to the lamp device for changing the brightness ratio of the second LED unit to the first LED unit and controlling the resulting color temperature of the lamp device.

### BACKGROUND

1. Technical Field

The present disclosure relates generally to a vehicle headlamp system and, particularly, to a vehicle headlamp system having light emitting diodes (LEDs).

2. Description of Related Art

In comparison with an incandescent lamp, such as a filament lamp, an LED has several advantages, such as better efficiency, lower heat loss, higher mechanical stability, and longer service life, and it can be applied to vehicle headlamps. A white light LED module may be provided by using a blue LED combined with a yellow-light emitting phosphor material. The mixture of these blue and yellow emitted lights can be perceived as white light by an observer. However, the related white light LED module usually has a higher color temperature between about 4500K and about 6500K, and the emitted light is harsh to the eye. In addition, the color rendering index (CRI) of the related white light LED module is merely about 80%, and the ability of reproducing the colors of various objects faithfully is insufficient for vehicle headlamps.

Moreover, visibility in rain, snow, and sleet can be significantly different. Invariably LED headlights are inconvenient and dangerous in such conditions.

It is of critical significance that the vehicle headlamp emits dependable light of the desired color temperature and intensity. Therefore, it is desirable to provide an LED vehicle headlamp system which can overcome the described limitations.

### BRIEF DESCRIPTION OF THE DRAWINGS

Many aspects of the disclosure can be better understood with reference to the drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a schematic functional block diagram of a vehicle headlamp system in accordance with a first embodiment of the present disclosure.

FIG. 2 is a schematic top view of the lamp device of FIG. 1.

FIG. 3 is a schematic partial cross section of the lamp device of FIG. 1.

FIG. 4 is a schematic top view of a lamp device in accordance with another embodiment of the present disclosure.

FIG. 5 is a schematic top view of a lamp device in accordance with yet another embodiment of the present disclosure.

### DETAILED DESCRIPTION

Embodiments of the disclosure will now be described in detail with reference to the accompanying drawings.

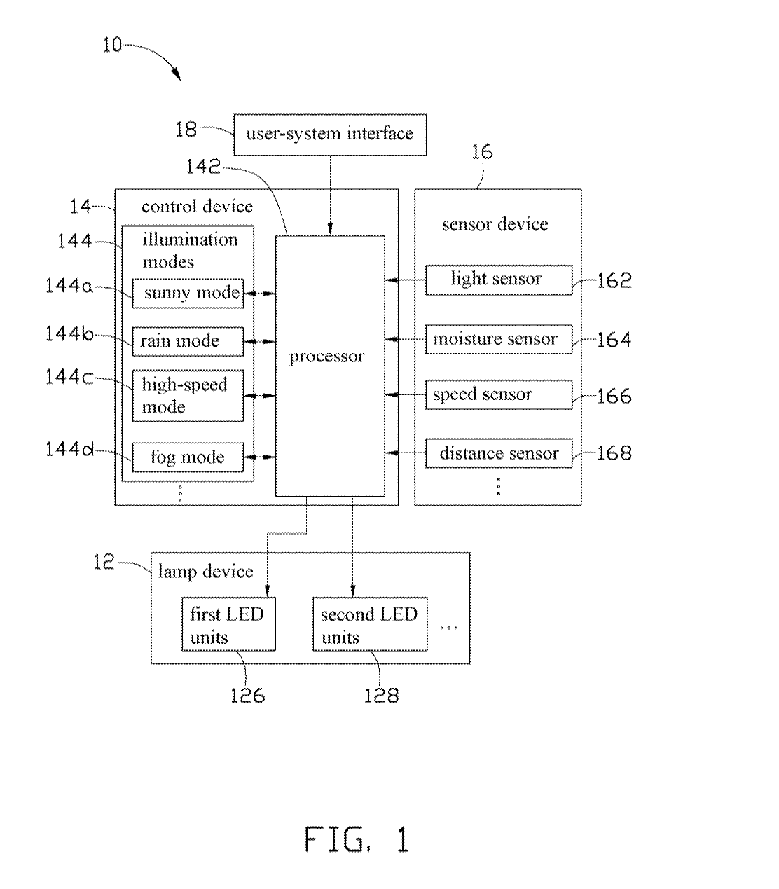

Referring to FIG. 1, a vehicle headlamp system 100 includes a lamp device 12 and a control device 14. In addition, the vehicle headlamp system 100 can further include a sensor device 16 and a user-system interface 18, but is not limited thereto.

The lamp device 12 includes a plurality of first LED units 126 providing a first color temperature, and a plurality of second LED units 128 providing a second color temperature different from the first color temperature. The number of the first LED units 126 may be quadruple to the number of the second LED units 128 for providing proper comfort to observers, but is not limited thereto. The total number of the first and second LED units 126 and 128 may be two to the power of n (2ⁿ, n is a natural number).

For providing a broad emission bandwidth in simple structure, the lamp device 12 may include first LED units 126 emitting in cold white color, and second LED units 128 emitting in warm color in this embodiment. The first color temperature is in a range from about 4500 Kelvin (K) to about 6500 K, and the second color temperature is less than about 3300 K. For example, the first and second LED units 126 and 128 may be white light LEDs and red light LEDs respectively.

The control device 14 is coupled to the lamp device 12 for changing the brightness ratio of the second LED units 128 to the first LED units 126 and controlling the resulting color temperature of the lamp device 12.

The first and second LED units 126 and 128 are supplied with electrical current by the control device 14. The intensity of the LED light emitted can be influenced by modulating the current flux. Thus, the mixing light of the first and second LED units 126 and 128, and consequently, the resulting color temperature of the lamp device 12 can be controlled.

Referring again to FIG. 1, the sensor device 16 may include at least a light sensor 162, moisture sensor 164, speed sensor 166, and distance sensor 168, but is not limited thereto. The information about ambient light, moisture, vehicle speed and distance from the front car can be transmitted from the sensor device 16 to the control device 14 for automatic modulation by the control device 14 or as adjustment references for the users.

The control device 14 may include a processor 142 to assign currents to the first and second LED units 126 and 128 according to information from the sensor device 16 or user-system interface 18. The control device 14 may store a plurality of illumination modes 144 therein, such as a sunny mode 144a, rain mode 144b, high-speed mode 144c, fog mode 144d, and each illumination mode 144 includes pre-set current parameters for color temperature or intensity. The control device 14 can thereby control the brightness of the first and second LED units 126 and 128 corresponding to the illumination modes 144 while in operation.

The user-system interface 18 enables convenient operation by a user, and for example, may be a computer keyboard. The user-system interface 18 may show the sensed information or a suggested illumination mode 144, and the user can input the illumination order through the user-system interface 18. Accordingly, a software program of the control device 14 can adjust the illumination of the vehicle headlamp system 100 automatically, or the user can manually adjust it.

With such a control device 14 and the first and second LED units 126 and 128, it is possible to implement any color progression and intensity profile. For example, the Gaussian profile of a conventional incandescent spotlight can be simulated as an intensity profile. The resulting color temperature of the lamp device 12 is in a range from about 2500 K to about 6500 K, and the color rendering index of the lamp device can be in a range from about 80% to about 85%. The emission bandwidths of the lamp device 12 may cover the entire visible spectral range.

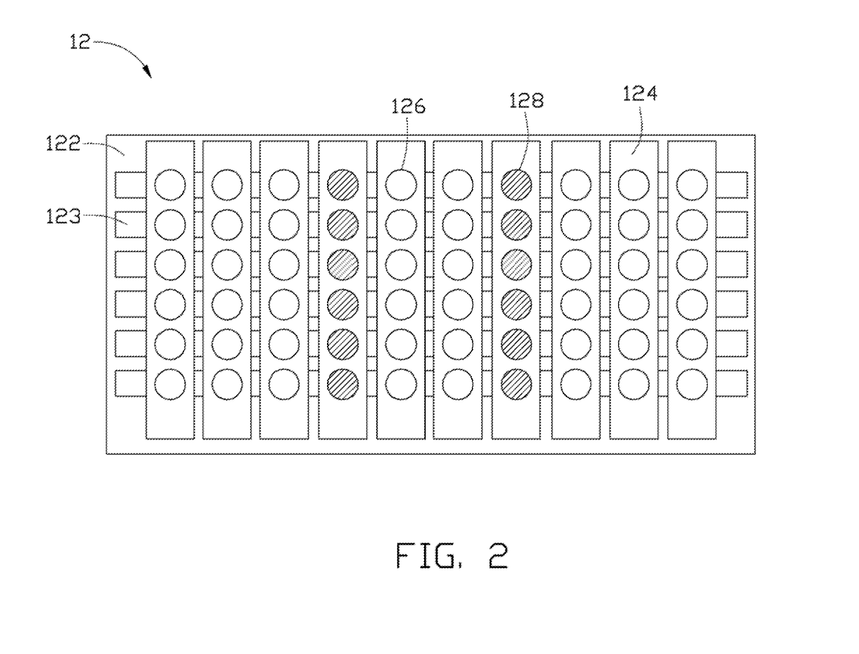

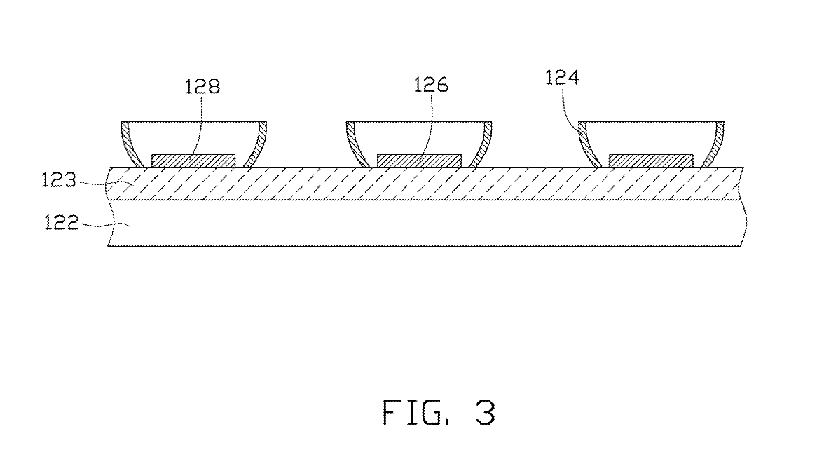

Referring to FIG. 2 and FIG. 3, the lamp device 12 may further include a base 122 and a plurality of reflectors 124. The lamp device 12 may further include a light guide, a lens or a transparent housing (not shown in the drawings) located above the first and second LED units 126 and 128 for protection and proper light distribution.

The base 122 is designed as a flat, and the first and second LED units 126, 128 are arranged as an array thereon in this embodiment. The base 122 may have any geometric shape, such as having a concave or convex surface in accordance with the vehicle body or for illumination control.

The first and second LED units 126 and 128 in one row are mounted on one carrier 123 as a light bar, and a plurality of light bars are arranged substantially parallel to form the array. The second LED units 128 are aligned in columns, but are not limited thereto. The reflectors 124 are reflective body with a plurality of openings for receiving the first and second LED units 126 and 128, and a concave surface for concentrating the emitted light. The reflectors 124 may have any geometric shape, such as flat with openings.

The control device 14 in FIG. 1 may progressively change the brightness of the first and second LED units 126 and 128 row by row, column by column, or one by one. For instance, when the car is driven from the mist to a sunny region, the first and second LED units 126 and 128 with a strong brightness may be progressively and continuously turned off row by row from the first row to the last row. Since each row has the same number ratio of the second LED units 128 to the first LED units 126, the color temperature in such an operation is about the same during the change. A sudden light change that may cause poor visibility is avoided. Due to the progressive operation, the light intensity of the lamp device 12 changes comfortably and safely to the observers, and the probability of breakdown can be reduced.

Not only the color temperature, the illumination distribution may also be modified by the control device 14. The first and second LED units 126 and 128 may cause different illumination distribution according to the arranged positions and angles of each LED unit, and other optical elements. For example, some LED units having a concentrated illumination distribution in a long range are supplied with high currents in a high beam mode, and are supplied with low currents or even no current in a dipped headlight mode.

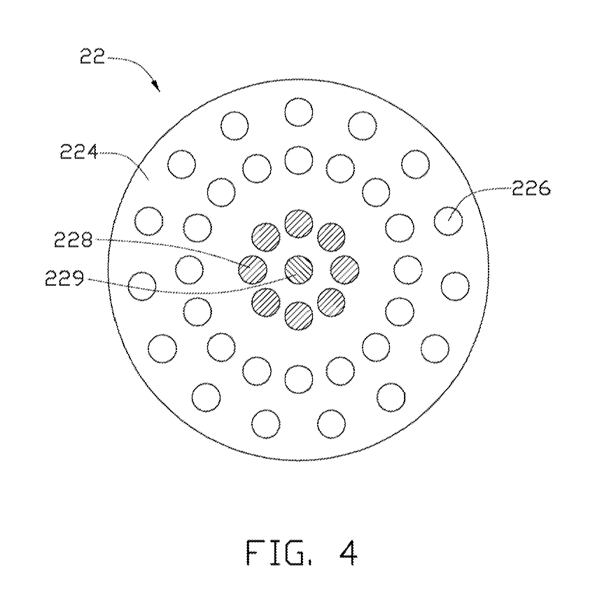

Referring to FIG. 4, main differences between the second embodiment and the first embodiment include the shape of the lamp device 22, the arrangement of LED units 226, 228, and 229 and the emitted light of the LED units 228 and 229.

The base (not shown) is covered by the reflector 224, and both the base and the reflector 224 have a round shape, such as circular in the top view. The lamp device 22 further includes at least a third LED unit 229 providing a third color temperature different from the first and second color temperatures. The first, second and third LED units 226, 228, and 229 are arranged in a plurality of concentric rings.

The first color temperature is in a range from about 4500 K to about 6500 K appearing in cold white color, the second color temperature is less than about 3300 K appearing in warm color, and the third color temperature exceeds 5300 K appearing in cool color. For example, the first, second and third LED units 226, 228 and 229 are white light LEDs, yellow (green) light LEDs and blue light LED respectively.

The first, second and third LED units 226, 228 and 229 are arranged in rings. The control device may progressively change the brightness of the first, second and third LED units 226, 228 and 229 ring by ring.

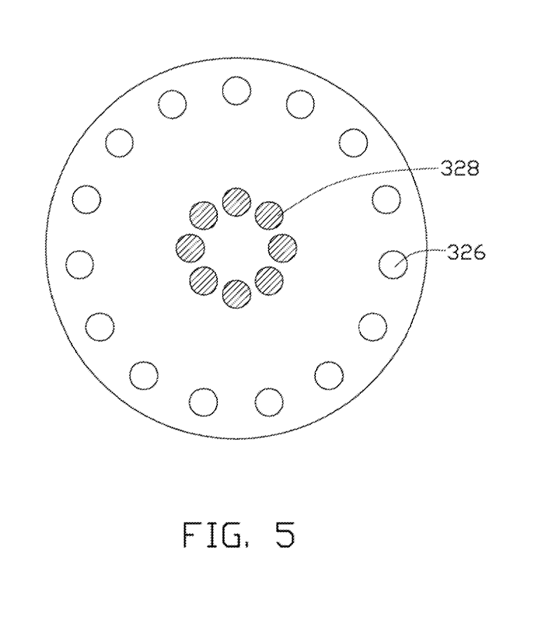

Referring to FIG. 5, the main differences between the third embodiment and the second embodiment is the emitted light of LED units 326 and 328. The first LED units 326 surround the second LED units 328. The number of the first LED units 326 is double to the number of the second LED units 328, and the total number of the first and second LED units 326 and 328 is twenty four in this embodiment. The first and second LED units 326 and 328 may be white light LEDs and red light LEDs respectively

With the improved color rendering index of the lamp device, more flexibility in the color temperature, intellectual control device, and pre-set suitable illumination modes for different conditions, the traffic safety is sufficiently improved.

It is to be understood, however, that even though numerous characteristics and advantages of various embodiments have been set forth in the foregoing description, together with details of the structures and functions of the embodiments, the disclosure is illustrative only; and that changes may be made in detail, especially in matters of arrangement of parts within the principles of the invention to the full extent indicated by the broad general meaning of the terms in which the appended claims are expressed.

What is claimed is:

1. A vehicle headlamp system, comprising:
a lamp device, comprising:
at least a first light emitting diode unit providing a first color temperature; and
at least a second light emitting diode unit providing a second color temperature different from the first color temperature;
a control device coupled to the lamp device for changing a brightness ratio of the at least a second light emitting diode unit to the at least a first light emitting diode unit and controlling a resulting color temperature of the lamp device.

2. The vehicle headlamp system of claim 1, wherein the first color temperature is in a range from about 4500 Kelvin (K) to about 6500 K.

3. The vehicle headlamp system of claim 2, wherein the at least a first light emitting diode unit is configured to emitting white light.

4. The vehicle headlamp system of claim 3, wherein the second color temperature is less than about 3300 K.

5. The vehicle headlamp system of claim 4, wherein the at least a second light emitting diode unit is configured to emitting red light.

6. The vehicle headlamp system of claim 5, wherein a number of the at least a first light emitting diode unit is quadruple to a number of the at least a second light emitting diode unit.

7. The vehicle headlamp system of claim 1, wherein the resulting color temperature is in a range from about 2500 K to about 6500 K.

8. The vehicle headlamp system of claim 4, wherein the at least a second light emitting diode unit is configured to emitting yellow light.

9. The vehicle headlamp system of claim 8, wherein the lamp device further comprises at least a third light emitting diode unit providing a third color temperature different from the first and second color temperatures.

10. The vehicle headlamp system of claim 9, wherein the third color temperature exceeds about 5300 K.

11. The vehicle headlamp system of claim 10, wherein the at least a third light emitting diode unit is configured to emitting blue light.

12. The vehicle headlamp system of claim 1, wherein the first and second light emitting diode units are arranged as an array.

13. The vehicle headlamp system of claim 12, wherein the control device progressively changes brightness of the first and second light emitting diode units line by line.

14. The vehicle headlamp system of claim 1, wherein the first and second light emitting diode units are arranged in a plurality of concentric rings.

15. The vehicle headlamp system of claim 14, wherein the control device progressively changes brightness of the first and second light emitting diode units ring by ring.

16. The vehicle headlamp system of claim 1, wherein a color rendering index of the lamp device is in a range from about 80% to about 85%.

17. The vehicle headlamp system of claim 1, further comprising a sensor unit configured to detect ambient light.

18. The vehicle headlamp system of claim 1, further comprising a sensor unit configured to detect moisture.

19. The vehicle headlamp system of claim 1, wherein the control device stores a plurality of illumination modes therein, and controls the brightness of the first and second light emitting diode units corresponding to the illumination modes.
